(19) United States
(12) Patent Application Publication
(10) Pub. No.: US 2015/0329132 A1
(43) Pub. Date: Nov. 19, 2015

(54) Transportation Device

(71) Applicant: NABU INDUSTRIES LIMITED, Warwick, Warwickshire (GB)

(72) Inventor: James Stuart McGregor, Warwick, Warwickshire (GB)

(21) Appl. No.: 14/654,339

(22) PCT Filed: Dec. 23, 2013
(86) PCT No.: PCT/GB2013/053427

§ 371 Date: Jun. 19, 2015

(30) Foreign Application Priority Data
Dec. 21, 2012 (GB) 1223323.5
Mar. 20, 2013 (GB) 1305108.1

(51) Int. Cl. B62B 1/24; B62B 1/20

(52) U.S. Cl. CPC B62B 1/24; B62B 1/202

(57) ABSTRACT

A transportation device comprising a container and a frame, the container includes a peripheral lip or flange having a concave lower surface, the frame having a roller, a fulcrum, a handle and a ground or substrate engaging portion to allow the transportation device to stand at rest. The frame is manoeuvrable, in use, to place the fulcrum under the peripheral lip or flange and to pivot the fulcrum about the roller.

This invention relates generally to a transportation device, for example a transportation container and/or cart or vehicle, such as a trolley or wheelbarrow. More specifically, although not exclusively, this invention relates to a transportation device with a removable container, for example a load carrying container.

Wheelbarrows are well known and normally include a bucket fixed to a frame that includes handles, a wheel and legs for engaging the ground so that the wheelbarrow can stand at rest. There has been a great deal of effort in designing such wheelbarrows in order to minimise the strain on a user when carrying heavy loads.

One development on standard wheelbarrows is disclosed in GB2368316, the contents of which are incorporated herein by reference. This document describes and claims a wheelbarrow with a bucket having outwardly extending pins that pivotably attach to corresponding hooks of a frame and wheel assembly. The frame includes a wheel, handle portions and leg portions so that the wheelbarrow can stand at rest.

Making the bucket pivot relative to the frame facilitates manoeuvrability of the wheelbarrow. Making the bucket detachable allows a user to fill the bucket on the ground and subsequently pick it up and transport the load.

However, the design disclosed in GB2368316 does not lend itself to very heavy loads and/or frequent attaching of the bucket to, and detaching the bucket from, the frame.

It is therefore a first non-exclusive object of the invention to provide a transportation device that overcomes or at least mitigates such issues. It is a more general non-exclusive object of the invention to provide an improved transportation device.

Accordingly, a first aspect of the invention provides a transportation device comprising a container and a frame, the container comprising a peripheral lip or flange having a concave lower surface, the frame comprising a roller, a fulcrum, a handle and a ground or substrate engaging portion to allow the transportation device to stand at rest, wherein the frame is manoeuvrable, in use, to place the fulcrum under the peripheral lip or flange and to pivot the fulcrum about the roller, e.g. using the handle, such that the fulcrum engages the concave lower surface of the peripheral lip or flange and raises the container.

The use of a container with a peripheral lip or flange that incorporates a concave engaging surface simplifies the attachment, transportation and detachment of the container to the frame. The inclusion of a peripheral lip or flange also provides a stiffer container.

The container may further comprise a connection or engaging point that may be at or adjacent at least one end of the container, for example wherein the frame may be manoeuvrable, in use, to engage the fulcrum with the one or more connection or engaging points, e.g. to tip the container.

According to a second aspect of the invention, there is provided a transportation device comprising a container and a frame, the container comprising a peripheral lip or flange having first and second connection or engaging points, the frame comprising a roller, a fulcrum, a handle and a ground or substrate engaging portion to allow the transportation device to stand at rest, wherein the frame is manoeuvrable, in use, to place the fulcrum under the peripheral lip or flange and to pivot the fulcrum about the roller, e.g. using the handle, such that the fulcrum either engages the first connection or engaging point to raise the container or engages the second connection or engaging point to tip the container.

The use of a container with first and second connection or engaging points that permit selective raising or tipping of the container greatly enhances the use of the transportation device.

The first connection or engaging point may comprise a concave lower surface and/or the second connection or engaging point may be at or adjacent one or a first end of the container. The device may comprise a third connection or engaging point, which may be at or adjacent the other or a second end of the container, e.g. opposite the one or first end.

The concave lower surface and/or the first connection or engaging point may be positioned substantially centrally of the container, e.g. at or adjacent the centre of side walls of the container, for example to enable the container to be raised in a substantially level orientation. Preferably, the concave lower surface and/or the first connection or engaging point comprises a pair of concave lower surfaces and/or first connection or engaging points, for example a respective one of each on either side of the container.

Additionally or alternatively, the second connection or engaging point may comprise a pair of second connection or engaging points each of which may be positioned at or adjacent one end of a respective side wall of the container. Additionally or alternatively, the third connection or engaging point may comprise a pair of third connection or engaging points each of which may be positioned at or adjacent one end of a respective side wall of the container.

The peripheral lip or flange preferably extends about the container's periphery, more preferably about the entire periphery of the container and most preferably, the peripheral lip or flange comprises a continuous or substantially continuous lip or flange that extends about the entire periphery of the container. Advantageously, the peripheral lip or flange comprises an outwardly extending peripheral lip or flange. In some embodiments, the peripheral lip or flange also includes a downwardly extending portion, for example to provide a substantially L-shaped lip or flange.

Additionally or alternatively, the second and/or third connection or engaging point(s) may comprise an interruption or gap or slot in the peripheral lip or downwardly extending portion thereof.

The fulcrum preferably comprises a rounded or substantially cylindrical portion or part, for example a shaft or pin. More preferably, the fulcrum comprises a pair of rounded or substantially cylindrical portions or parts, for example shafts or pins that may extend inwardly.

The container may comprise sides that have a sloping upper portion, for example with an apex at or adjacent their centre. The concave lower surface of the peripheral lip or flange may comprise two or more, e.g. a pair of concave lower surfaces, which is or are preferably at or adjacent or correspond to the apex. For example the concave lower surface or surfaces may be at or adjacent or comprise or correspond to a corner portion of the peripheral lip or flange, e.g. from which opposite portions of the peripheral lip or flange slope downwardly away. The second and/or third connection or engaging points may comprise or be positioned at lower or outer portions of the peripheral lip or flange, for example spaced from the apex, e.g. at one or each side thereof.

The frame may comprise a pair of handles or handle portions, for example which extend away from the roller, which handle or handles may be extendable. The frame may further comprise one or more cross-beams and/or struts that extend laterally or transversely of the frame and/or which join the handles or handle portions. The ground or substrate engaging portion may comprise one or more, e.g. a pair of, legs or feet or elbows or foot or elbow portions, which ground or substrate engaging portion or legs or feet or elbows or foot or elbow portions may be extendable. The frame may comprise one or more further cross-beams and/or struts that extend laterally or transversely of the frame and join the legs or feet or elbows or foot or elbow portions. The device or frame may comprise two rollers, one or more or each of which may comprise a wheel, for example one on each side of the frame or device, and/or an axle to which a respective one of the rollers is mounted at or adjacent each of its ends. Preferably, the rollers or wheels are outboard of the container when the container is mounted to the frame. More preferably, the fulcrum is between the roller or rollers and the handle or handles or handle portion or portions.

The frame may comprise a first frame member that joins the handle or handle portion to the roller and/or a second frame member that joins the ground or substrate engaging portion to the fulcrum and/or a third frame member that joins the roller to the fulcrum. The roller is preferably rollably mounted to the first and third frame members. Preferably, the frame comprises an axle to which a respective roller is mounted at one of its ends. More preferably, the frame comprises a pair of first frame members and/or a pair of second frame members and/or a pair of third frame members. Most preferably, a respective one of each of the first and third frame members is connected to one end of the axle and the other of each of the first and third frame members is connected to the other end of the axle. The frame may also comprise a pair of cross-beams to provide a three-dimensional frame with an opening for receiving the container, which is preferably suspended from the frame by the fulcrum.

The device may be configured such that the centre of gravity of a load contained, in use, within the container is between the handle or handles and the roller or rollers when the device is standing at rest with the container mounted thereto. Additionally or alternatively, the device may be configured such that the centre of gravity of a load contained, in use, within the container is or may be manoeuvred to be substantially over the roller, e.g. the axis or axle of the roller, when the device is moved or pushed or conveyed, for example by a user of average size and/or build. Additionally or alternatively, the device may be configured such that a loaded container will remain substantially level when the device is moved or pushed or conveyed.

The device may also incorporate a lock or locking means, for example to fix the container relative to the frame. The lock or locking means may comprise a retractable pin mounted to the frame, which pin may be configured to engage a hole or aperture or recess in or on the container.

A third aspect of the invention provides a frame, e.g. for use in a transportation device as described above, which frame preferably comprises one or more of a roller and/or a fulcrum and/or a handle and/or a ground or substrate engaging portion to allow the transportation device to stand at rest. This aspect of the invention may include any one or more of the frame features described above in relation to the transportation device.

A fourth aspect of the invention provides a container, e.g. for use in a transportation device as described above, which container preferably comprises a peripheral lip or flange, which lip or flange may have a concave lower surface and/or one or more connection or engaging points. This aspect of the invention may include any one or more of the container features described above in relation to the transportation device.

A fifth aspect of the invention provides a kit of parts for assembly into a transportation device according to the first aspect of the invention, the kit comprising at least one frame according to the third aspect of the invention and at least one, preferably two or more, containers according to the fourth aspect of the invention.

A sixth aspect of the invention provides a method of transporting a load, the method comprising placing one or more objects or materials in a container having a peripheral lip or flange with a concave lower surface, e.g. a container as described above, placing the fulcrum of a frame under the peripheral lip or flange, pivoting the fulcrum about a roller of the frame, e.g. using a handle of the frame, such that the fulcrum engages the concave lower surface of the peripheral lip or flange and raises the container.

A seventh aspect of the invention provides a method of transporting a load, the method comprising placing one or more objects or materials in a container having a peripheral lip or flange with first and second connection or engaging points, e.g. a container as described above, placing the fulcrum of a frame under the peripheral lip or flange, pivoting the fulcrum about a roller of the frame, e.g. using a handle of the frame, such that the fulcrum engages the second connection or engaging point to tip the container.

The method may further comprise transporting the load, for example by moving or pushing the transportation device, e.g. such that the roller engages and/or rolls along a substrate, for example the ground.

Embodiments of the invention will now be described by way of example only with reference to the accompanying drawings in which:

FIG. 1 is a perspective view of a first embodiment of transportation device according to the invention shown in a first configuration in which it is at rest;

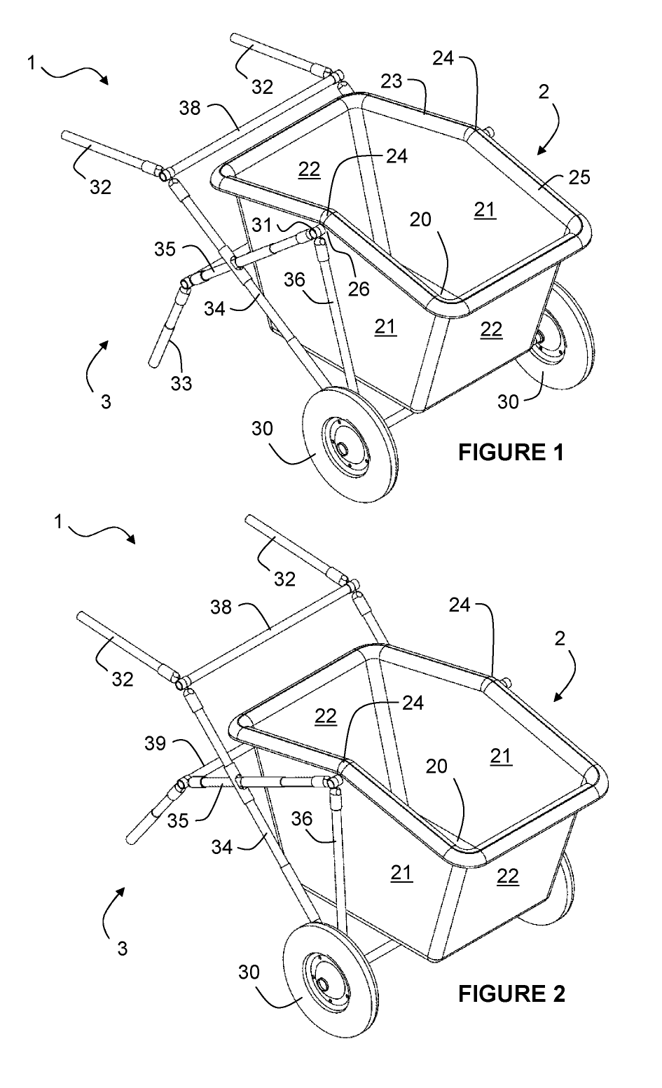

FIG. 2 is a view similar to that of FIG. 1 with the transportation device in a second, conveying configuration;

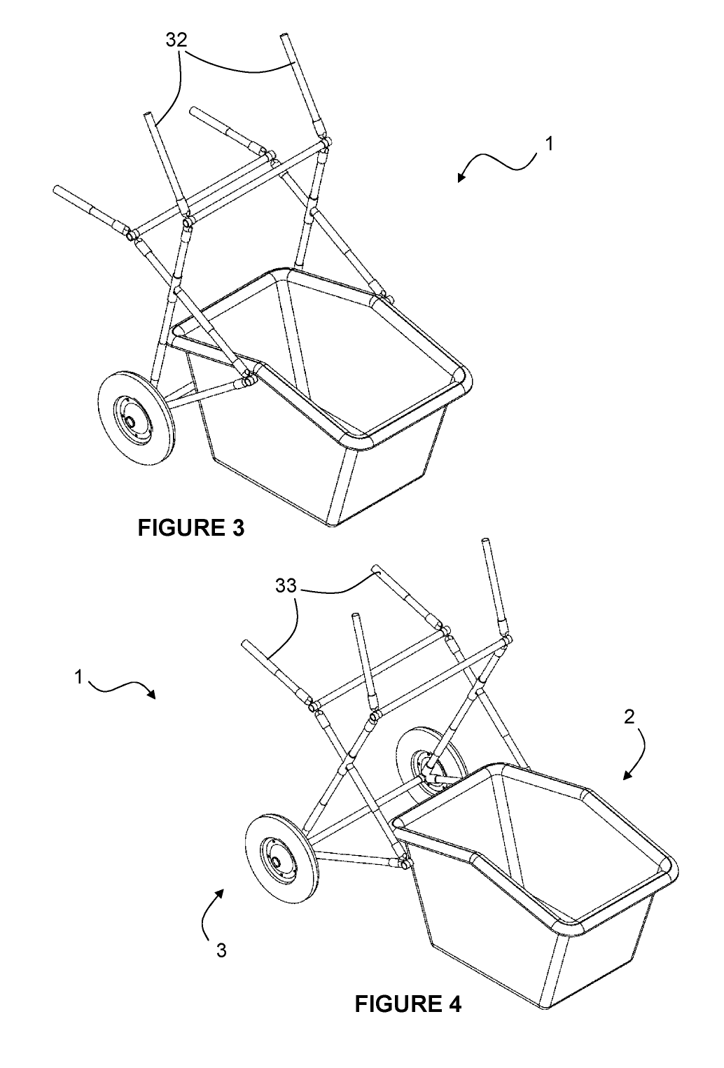

FIG. 3 is a view similar to that of FIGS. 1 and 2 with the transportation device in a third, discharging configuration;

FIG. 4 is a view similar to that of FIGS. 1 to 3 with the transportation device in a fourth, retracted configuration;

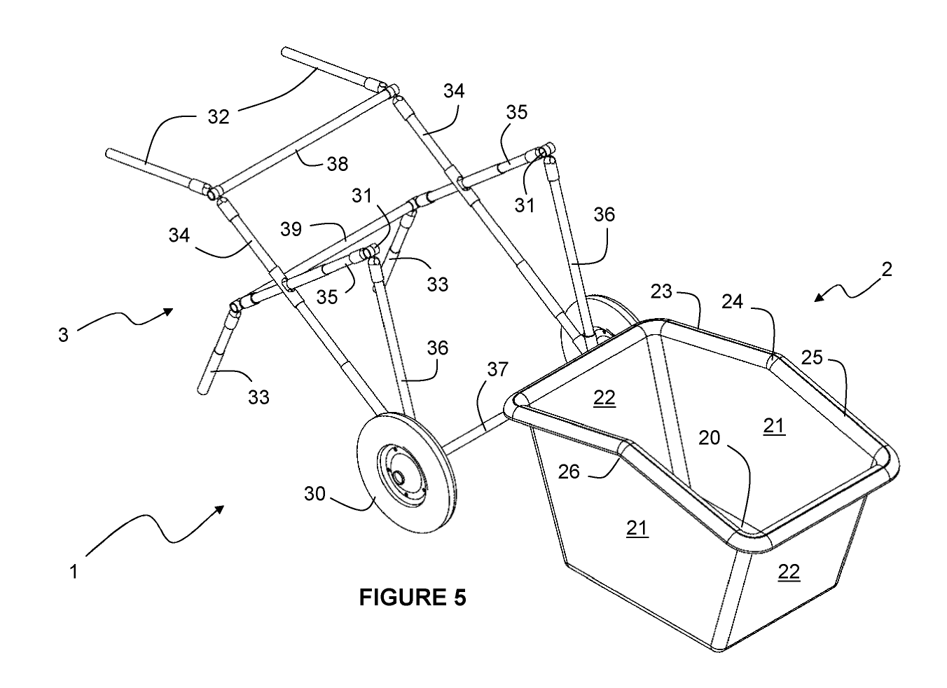

FIG. 5 is a perspective view of the transportation device of FIGS. 1 to 3 with the frame and container shown separated from one another;

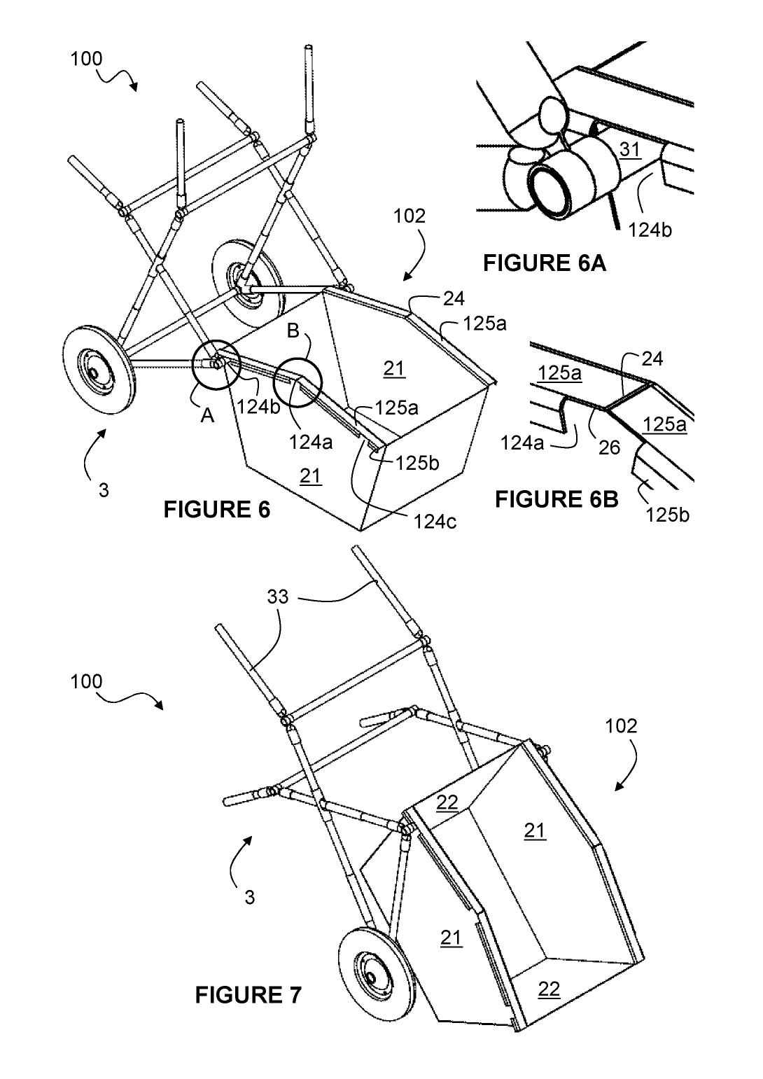

FIG. 6 is a perspective view of a transportation device according to a second embodiment of the invention illustrating the frame engaging the container at an off-centre engaging point; and

FIG. 7 is a view similar to that of FIG. 6 illustrating the tipping of the container.

Referring now to FIGS. 1 to 5, there is shown a transportation device 1 according to a first embodiment of the invention that includes a loading container 2, in the form of a mini-skip 2, and a transportation frame 3 for picking up and transporting the container 2 when it is fully loaded.

The container 2 has a rectangular base 20, side walls 21 extending orthogonally from the base 20 and end walls 22 extending at an obtuse angle from the base 20 and connecting the ends of the side walls 21 together, thereby to provide a container substantially in the shape of a standard skip. The side walls 21 have respective upper edges 23 that slope upwardly from their ends toward their centre to form an apex 24.

The container 2 also includes an outwardly extending continuous peripheral lip or flange 25 about the entire periphery of the container 2 along its upper edges. The portions of the flange 25 that correspond to the apexes 24 each provide a concave, downward facing lower engaging surface 26.

The frame 3 includes a pair of rollers or wheels 30, a pair of pins 31 that together provide a fulcrum, a pair of handles 32 and a pair of extendable ground or substrate engaging legs 33 to allow the transportation device 1 to stand at rest as shown in FIG. 1. The frame 3 includes a pair of first frame members 34, each of which joins one of the handles 32 to a respective one of the rollers 30. The frame 3 also includes a pair of second frame members 35, each of which joins one of the legs 33 to a respective one of the pins 31. The frame 3 also includes a pair of third frame members 36, each of which joins the one of the rollers 30 to one of the pins 31. The frame 3 also includes an axle 37 to which a respective roller 31 is mounted at one if its ends, and two cross-beams 38, 39. A respective of each of the first and third frame members 34, 36 is connected to one end of the axle 37 and the other of each of the first and third frame members 34, 36 is connected to the other end of the axle 37. One cross-beam 38 connects the handles 32 and the other cross-beam 39 connects the legs 33 to provide a three-dimensional frame 3 with an opening that receives the container 2, which is suspended from the frame 3 by the pins 31.

In use and as shown in reverse sequence from FIG. 2 to FIG. 5, the frame 3 is manoeuvrable to place the pins 31 under the peripheral flange 25 (see FIGS. 4 and 3), to pivot the frame 3 about the rollers 30 using the handles 32 such that the pins 31 contact the engaging surface 26 of the peripheral flange 25 and raises the container 2. The transportation device 1 is then moved by pushing it such that the roller rolls along the ground.

The device 1 is configured such that the centre of gravity of a load contained within the container 2 is between the handles 32 and the rollers 31 when the device 1 is standing at rest with the container 2 mounted thereto as shown in FIG. 1. The centre of gravity of the load is also configured to be over the axle of the rollers 31 when the device 1 is pushed by a user of average size and/or build and the loaded container 2 remains substantially level when the device 1 is conveyed along the ground.

Referring now to FIGS. 6 and 7, there is shown a transportation device 100 according to a second embodiment of the invention similar to the transportation device 1 according to the first embodiment, wherein like reference depict like features that will not be described herein. The device 100 according to this embodiment includes a loading container 102 that differs from the loading container 2 of the first embodiment in that the peripheral flange 125 includes three engaging points 124a, 124b, 124c on each side of the container 102.

The flange 125 is substantially L-shaped and includes a support portion 125a that extends perpendicularly from the sidewalls 21 of the container 102 and a downwardly extending portion 125b with three slots or interruptions along each side of the container 102 that provide the engaging points 124a, 124b, 124c. A first slot 124a is located at the centre of a respective apex 24 to allow the pins 31 to be inserted and to engage the concave, downward facing lower engaging surface 26. Second and third slots 124b, 124c are located at respective end portions of the sidewalls 21 to allow the pins 31 to be inserted and to engage corresponding lower surfaces of the support portion 125a.

In use, the frame 3 is manoeuvrable to place the pins 31 under the peripheral flange 125 in a similar manner to that shown in relation to the first embodiment. The user can insert the pins 31 into the central slots 124a and pivot the frame 3 about the rollers 30 using the handles 32 such that the pins 31 contact the engaging surface 26 of the peripheral flange 125 raise the container 102. The transportation device 100 is then moved by pushing it such that the roller rolls along the ground.

However, with this embodiment, the user may also insert the pins 31 into one of the outer slots 124b, 124c and pivot the frame 3 about the rollers 30 using the handles 32 such that the pins 31 contact the lower surface of the corresponding region of the support portion 125a of the flange 125 and tip the container 102 as shown in FIGS. 6 and 7.

It will be appreciated by those skilled in the art that any number of combinations of the aforementioned features and/or those shown in the appended drawings provide clear advantages over the prior art and are therefore within the scope of the invention described herein.

1. A transportation device comprising a container and a frame, the container comprising a peripheral lip or flange having a concave lower surface, the frame comprising a roller, a fulcrum, a handle and a ground or substrate engaging portion to allow the transportation device to stand at rest, wherein the frame is manoeuvrable, in use, to place the fulcrum under the peripheral lip or flange and to pivot the fulcrum about the roller.

2. A transportation device as claimed in claim 1 further comprising a connection or engaging point adjacent to at least one end of the container to engage the fulcrum with the one or more connection or engaging points.

3. A transportation device comprising a container and a frame, the container comprising a peripheral lip or flange having first and second connection or engaging points, the frame comprising a roller, a fulcrum, a handle and a ground or substrate engaging portion to allow the transportation device to stand at rest, wherein the frame is manoeuvrable, in use, to place the fulcrum under the peripheral lip or flange and to pivot the fulcrum about the roller, such that the fulcrum either engages the first connection or engaging point to raise the container or engages the second connection or engaging point to tip the container.

4. A transportation device as claimed in claim 3 wherein the first connection or engaging point comprises a concave lower surface and/or the second connection or engaging point, which is at or adjacent one or a first end of the container.

5. A transportation device as claimed in claim 3, comprising a third connection or engaging point, is at or adjacent the other or a second end of the container.

6. A transportation device as claimed in claim 3, wherein the concave lower surface and/or the first connection or engaging point is positioned substantially centrally of the container to enable the container to be raised in a substantially level orientation.

7. (canceled)

8. A transportation device as claimed in claim 3 wherein the second connection or engaging point comprises a pair of second connection or engaging points each of which is positioned at or adjacent one end of a respective side wall of the container.

9. A transportation device as claimed in claim 3 wherein the third connection or engaging point comprises a pair of third connection or engaging points each of which is positioned at or adjacent one end of a respective side wall of the container.

10. (canceled)

11. A transportation device as claimed in claim 3 wherein the peripheral lip or flange comprises an outwardly extending peripheral lip or flange, preferably, the peripheral lip or flange also includes a downwardly extending portion, for example to provide a substantially L-shaped lip or flange.

12. A transportation device according to claim 3, wherein the second and/or third connection or engaging point(s) comprises an interruption or gap or slot in the peripheral lip or downwardly extending portion thereof.

13. (canceled)

14. A transportation device according to claim 3 wherein the fulcrum comprises a pair of rounded or substantially cylindrical portions or parts such as shafts or pins that preferably extend inwardly.

15. (canceled)

16. A transportation device according to claim 3 wherein the container comprises sides that have a sloping upper portion with an apex at or adjacent their centre whereby, in use, the pair of concave lower surfaces of the peripheral lip or flange, or the second and/or third connection or engaging point(s) are adjacent or correspond to the apex.

17. (canceled)

18. (canceled)

19. (canceled)

20. (canceled)

21. A transportation device according to claim 3 wherein the frame comprises two rollers, one or more of each of which comprise a wheel, one on each side of the frame or device, and an axle to which a respective one of the rollers is mounted at or adjacent each of its ends.

22. A transportation device according to claim 3 wherein the centre of gravity of a load contained within the container is between the handle or handles and the roller or rollers when the device is standing at rest with the container mounted thereto, and such that the centre of gravity of a load contained within the container is substantially over the roller when the device is moved or pushed or conveyed.

23. (canceled)

24. A container for use in a transportation device as claimed in claim 3 which container comprises a peripheral lip or flange, which lip or flange has a concave lower surface and/or one or more connection or engaging points.

25. (canceled)

26. A transportation device according to claim 3 in the form of a kit of parts for assembly.

27. A method of transporting a load, the method comprising the following steps:
placing one or more objects or materials in a container having a peripheral lip or flange with a concave lower surface and/or one or more connection or engaging points;
placing a fulcrum of a frame having one or more members selected from the group consisting of: a roller, fulcrum, handle, ground or substrate engaging portion to allow the transportation device to stand at rest under the peripheral lip or flange; and
pivoting the fulcrum about a roller of the frame such that the fulcrum engages a lower surface of the peripheral lip or flange and raises and/or tips the container.

28. A transportation device comprising a container and a frame, the container comprising a peripheral lip or flange, the frame comprising a roller, a fulcrum, a handle and a ground or substrate engaging portion to allow the transportation device to stand at rest, wherein the frame is manoeuvrable, in use, to place the fulcrum under the peripheral lip or flange and to pivot the fulcrum about the roller.
